(19) United States
(12) Patent Application Publication
(10) Pub. No.: US 2015/0183056 A1
(43) Pub. Date: Jul. 2, 2015

(54) METHOD FOR PRODUCING GLOSS EFFECTS ON PRESSING TOOLS

(71) Applicant: SANDVIK SURFACE SOLUTIONS DIVISION OF SANDVIK MATERIALS TECHNOLOGY, Ennepetal (DE)

(72) Inventor: Ralf Niggemann, Kierspe (DE)

(21) Appl. No.: 14/423,444

(22) PCT Filed: Aug. 23, 2013
(86) PCT No.: PCT/EP2013/067540

§ 371 Date: Feb. 24, 2015

(30) Foreign Application Priority Data
Aug. 24, 2012 (DE) 10 2012 107 827.0

(51) Int. Cl. B23K 26/00; B23K 15/00; B23K 26/06; B23K 26/03

(52) U.S. Cl. CPC B23K 26/0081; B23K 26/03; B23K 15/00; B23K 26/063

(57) ABSTRACT

A method for adjusting the gloss level of a structured surface of a pressing tool, for example, a pressing sheet or pressing belt, is provided. An energetic beam, in particular a laser beam, is used to remelt at least part of the surface to a depth of 1 to 5 μm, more particularly from 1 to 3 μm. A method is thus produced that is substantially quicker and cheaper with respect to conventional polishing methods for pressing plates and which can be used to change the gloss level of the tool surface that is independent of the surface structure.

The invention relates to a method for adjusting the gloss level of a structured surface of a pressing tool, in particular of a press plate or press belt.

Surface structured, large format press belts (also called endless press belts) and press plates serve to provide substrates, such as in particular panel or strip material, with a surface structure for decorative or technical purposes. Surface structured panel or strip material is used for example in the furniture, flooring, construction and commercial vehicle industries. The material is produced for example from various plastic materials. Chipboard, plywood and MDF boards are likewise used, and these are coated on their use side (top) or bottom with films/papers/decor saturated with melamine resin. In the production of flooring or commercial vehicle flooring as well as in structural panels, a defined portion of corundum materials is also added to the melamine film/paper on the use surface in order to provide the use surface of the panel with the required abrasion resistance. For decorative applications the surfaces of the panels are provided with decorative structures such as wood, stone, or other structures (for example bead-shaped or fine-grained surface structures, etc.). Panels for the construction and commercial vehicle industries are provided for example with technical-geometrical structures, such as rhomboid structures, wells or ribbing to bring about slip resistance for example.

Double-belt presses and heating presses are used in the production of panel material. Individual press plates with the panel to be stamped (panel for stamping) or coffered sheet stacks of pairs of press plates and panels for stamping are used in the heating presses. The panels for stamping are stamped at a defined pressure and temperature in the presses.

Production of the above-mentioned pressing tools, which are usually made from a steel material, is usually carried out by applying a structured, etch-resistant mask to the surface of the pressing tool to be structured and subsequently etching the masked surface. The etch-resistant mask is conventionally printed onto the surface. After etching, the mask is removed mechanically or electrolytically and the surface is cleaned. This process is repeated with different structured masks until the desired final structure is achieved. The structure is therefore formed by creating a height profile on the surface in the form of the mask(s). Another way of creating a structure on the surface is to reshape the surface in part or entirely, for example by sand blasting with appropriate hard blasting material, so surface effects are produced hereby which can then be transferred from the pressing tool to the panel for stamping.

As a rule the structured surface of the tool is chrome-plated. Its life is increased as a result, a defined gloss level of the panel surface to be produced is adjusted and easier demoulding of the panel after stamping is enabled (detachment of the pressing tool from the panel for stamping). The surface structure of the pressing tool then corresponds to the negative of the surface structure to be produced on the panel material. Printing and etching of the pressing tools is over the entire surface in each case.

The respective smooth pressing tools are produced before surface structuring by appropriate grinding and polishing operations. In these operations the surfaces of the press belts or press plates are each machined mechanically over the entire surface, so a homogeneous and very uniform surface, and, on polishing, a surface gloss are produced.

The partial polishing of structured surfaces of pressing tools is used to generate additional gloss effects. These additional effects applied to the existing structured surface mean the surface appearance of the panel for stamping can be lastingly improved in terms of its overall visual effect (e.g. improved nature-identical representation of a wood decoration, shimmering surfaces, etc.). A gloss effect can be produced, for example, by very slight sanding of a surface that has already been chrome-plated. The thickness of the applied chrome layer has to be such that sanding of the surface with an optimally fine abrasive medium is possible (e.g. sanding belt K1000) without the chrome layer being broken up by the sanding process. The highest elevations of a structure can therefore be so finely smoothed that a strong gloss effect is produced. The smoothed structural elements will then let the structural base of the panel for stamping appear much brighter in a pressing than the remaining structural region. One drawback of this method is that it is only possible to polish the raised structural elements of the structure on a pressing belt or pressing sheet with this machining. This significantly restricts possible design variants.

Another method is described in DE 10 2007 055 053 A1 in which, for machining a structured surface of a pressing tool in which the entire surface is provided with a first metallic coating and a second additional metal coating is arranged on the first, wherein the gloss level of the first coating differs from that of the second coating.

Gloss effects can also be produced by an electrolytic process. In this case a structure is printed on the press belt or press plate to be polished. The surface is subsequently polished in an electrolytic process. The printing ink used protects structural regions from electrolytic attack, so only the non-printed regions are polished. After removing the printed structure the regions which are now exposed again appear with the original gloss which is usually much duller.

The method disclosed in DE10 2007 055 053 A1 and the electrolytic process are complex and, depending on the desired finish, render a plurality of steps necessary (printing, etching or polishing, cleaning). Some of these steps must be repeated several times with new printing processes each time. Moreover, these methods are critical in relation to ecological safety, and they require a high energy demand.

The claimed invention has the object of providing a more efficient method with respect to said drawbacks. This object is achieved with a method having the features of claim 1.

Here and below the surface of the pressing tool is taken to mean the surface of the pressing tool effective during stamping of a panel for stamping.

Laser radiation is primarily considered as the energetic radiation. A different kind of energy radiation can be used, however, such as electron beam radiation, with which sufficient energy can be coupled into the surface so it is remelted up to a depth of 1 to 5 μm (preferably up to a depth of 1 to 3 μm).

During remelting of the surface of the pressing tool in a range from <=5 μm, the material is melted but not removed, or removed only to a small extent. This means that the macrostructure of the pressing tool surface, i.e. the pattern to be stamped is retained. However, the material is re-distributed on the surface due to the remelting, so the microstructural surface roughness is already reduced hereby. A fine-grained material structure may form, moreover, after rapid cooling following melting of the material. This also produces a smoother structure. Finally, the surface roughness can also be reduced by slight abrasion of the surface due to evaporation of surface material. A surface with a comparatively very sight surface roughness is therefore created by the remelting of the top surface layer. A surface of this kind inevitably has a higher gloss level than the surface before treatment with the energetic radiation.

For the purpose of remelting, the energetic radiation is expediently performed line by line or in a meandering manner over individual portions of the pressing tool surface or over the entire surface of the pressing tool. The adjacent lines may overlap in this case. The line width matches the width of the radiation and can be for example in a range from 50 to 500 pm. A track offset can be for example between 10 and 200 μm.

The gloss level can be continuously varied by varying the laser parameters such as energy, radiation width and feed rate of the radiation on the surface, so certain portions receive a higher gloss level than others. This allows further optical effects to be generated on the pressing tool and therewith on the panel for stamping to be produced.

The inventive method can be carried out in one operation, without the need for additional steps or additional coatings of the surface. Previous steps for treating the surface with an energetic beam, with which the surface is re-melted to a much deeper extent, as is described for example in DE 103 42 750.3, and which relates to a similar surface treatment for polishing and structuring tool surfaces, are just as unnecessary. This has to do in particular with the fact that the surface of the pressing tool has already undergone surface treatment to produce its surface structure, has been etched for example. If the treatment of the surface of a pressing tool surface is to be repeated once or several times then it makes sense to rotate the machining direction by 90° to improve the smoothing result.

Of course the surface machined according to the invention can nevertheless be subsequently coated, for example to give it a particular mechanical or chemical resistance. The changes in gloss level introduced by way of the surface treatment according to the invention are not significantly changed hereby. The surface treated according to the invention can therefore preferably be provided with a chrome coating, for example having a thickness in a range from 6 to 12 μm.

The inventive method is particularly well suited for pressing tools with a surface made of steel, and in particular a pulsed energetic beam is used far remelting. A continuous radiation may also be used, however.

The remelting duration is preferably 1 to 10 s/cm².

Examples of a radiation source are in particular a Nd:YAG laser or an excimer laser. The power of the energetic radiation is preferably in a range from 50 to 250 W. The focus of the radiation source is preferably in a range from 150-400 μm.

In a preferred embodiment of the method according to the invention the re-melting occurs as a function of the structural depth of the macrostructure of the surface, with a sensor being provided which runs ahead of the energetic beam and with which the structural depth is determined at a point on the surface, and the energetic beam is switched on and off as a function of the determined structural depth. It is therefore possible to define specific structural depth ranges in which the gloss level of the surface is to be changed. For example, the gloss level can be changed substantially only in the structural base, i.e. in deepest regions of the macrostructure of the surface. Additionally or alternatively, it is possible to increase or to change the gloss level of the macrostructure in the highest regions of the macrostructure and/or in one or more plane(s) between the structure base and the highest regions of the macrostructure. Completely novel optical effects, for example, a change in the perceived gloss level of the surface of a panel for stamping depending on the perspective of the viewer, may therefore be achieved on a panel for stamping that is to be produced with the pressing tool.

Structural planes or structural regions whose gloss level is to be improved can be specified for example by way of a software controller. The macrostructure of the surface may therefore have a depth of about 100 μm for example, and it is determined that the structure is remelted in the regions in which the surface is 30 to 70 μm higher than the structural base, i.e. the lowest plane of the structure of 100 μm. In addition, planar portions of the surface can be determined in which a surface treatment should basically not take place, or in which it should basically take place over the entire surface, or just as a function of the height profile of the (macro) structure of the surface. The radiation is then switched on if the measuring sensor has found that the height of the structural profile is located in the region determined for machining, and/or if the radiation source is located in a surface portion in which a surface treatment is to take place. If at least one of these two conditions does not apply, the radiation source is or remains switched off. The gloss level to be achieved with the treatment can be predetermined in this way as a function of the respective position of the radiation source.

Therefore not only optical effects, but all of the image information can be transferred to the surface of the pressing tool, with specific gloss levels corresponding for example to different grey values of a greyscale image.

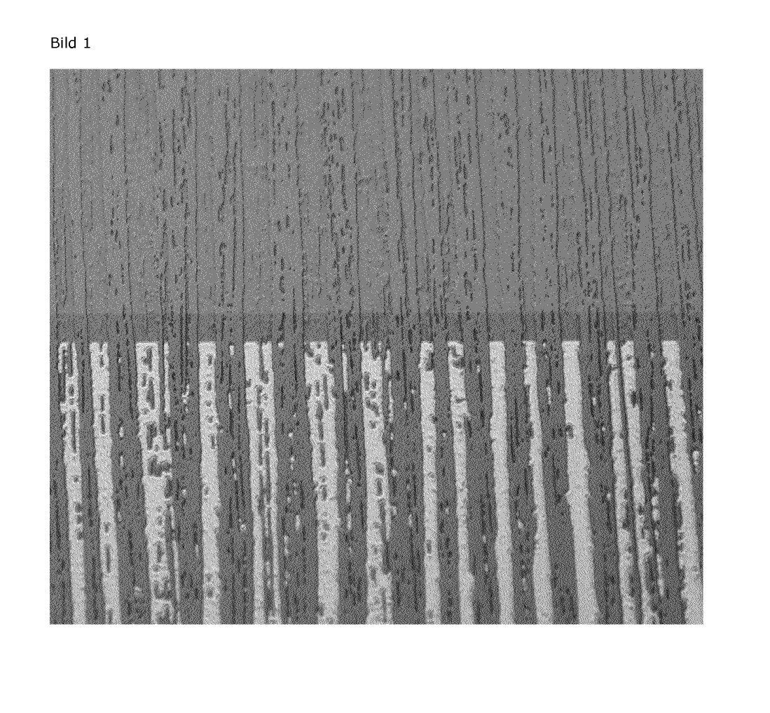

Examples of a gloss level adjustment with the method according to the invention can be found in FIGS. 1 to 3 which show examples of portions of pressing sheets that were produced by the method according to the invention.

FIG. 1 shows a press plate surface whose bottom half in the figure was treated with the inventive method. It can be seen that the entire bottom half of the sheet was surface-treated, with the surface structure in previously determined strip sections having a different gloss level in the regions which, compared to the adjacent regions of the structure, have a specific minimum height relative to the structural base.

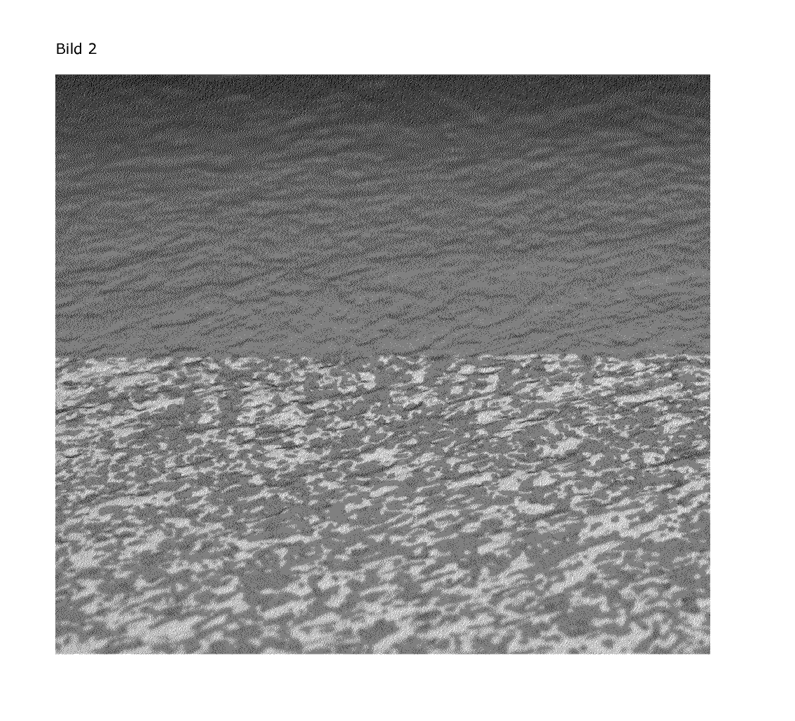

FIG. 2 shows a press plate surface whose bottom portion in the figure is surface-treated according to the invention such that about 50% of the entire surface has a higher gloss level. For this purpose all parts of the structured surface, which are located in a region between 25% to 75% of the total height of the surface structure, were surface-treated according to the invention. The surface structure in the structural base and in its upper regions is therefore at a lower gloss level.

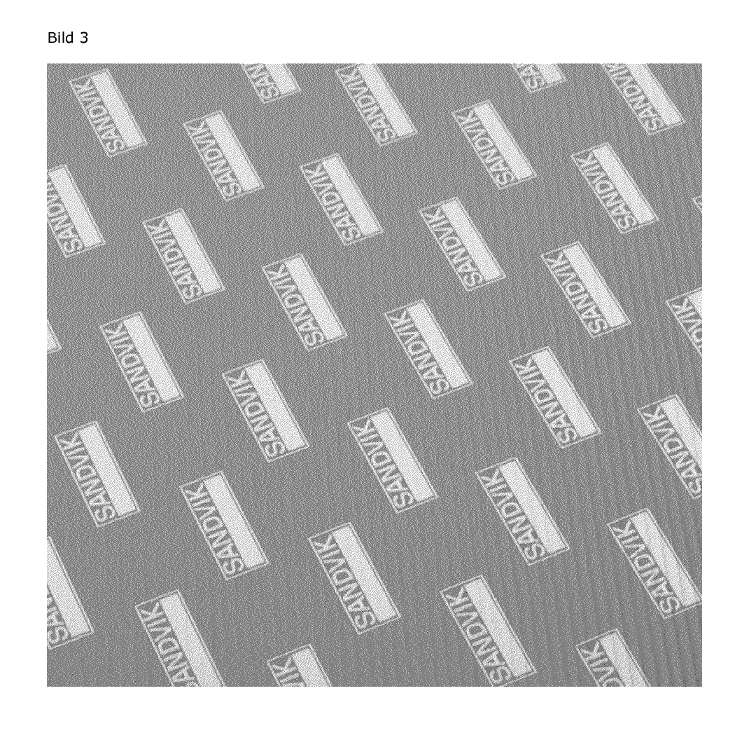

It can be seen in FIG. 3 that, distributed over the entire illustrated pressing sheet surface, the Applicant's logo is reproduced with a changed gloss level, here completely independently of the respective depth of the surface structure. Reproduction of the logo was likewise achieved with the method according to the invention.

1. A method for adjusting the gloss level of a structured surface of a pressing tool, in particular of a press plate or press belt, comprising the step of remelting with an energetic beam, at least part of the surface to a depth of 1 to 5 μm.

2. The method according to claim 1, wherein the press plate is made from a steel material, and a pulsed energetic beam is used for remelting.

3. The method according to claim 2, wherein a duration of the remelting is 1 to 10 s/cm².

4. The method according to claim 1, wherein the energetic beam is selected from an Nd:YAG laser or an excimer laser.

5. The method according to claim 1, wherein the energetic beam has a power of 50 to 250 W.

6. The method according to claim 1, wherein the remelting is carried out as a function of a structural depth of the surface, wherein a sensor is provided which runs ahead of the energetic beam and with which the structural depth is determined at a point on the surface, and the energetic beam is switched on and off as a function of the determined structural depth.

7. The method according to claim 1, wherein image information is transmitted to the surface by the remelting.

8. The method according to claim 7, wherein the surface is remelted all over within boundaries of the image information to be transmitted.

9. The method according to claim 1, wherein the entire surface is selectively polished in one operation.

10. The method according to claim 1, wherein remelting of the surface takes place line by line.

11. The method according to claim 1, wherein the at least part of the surface is remelted to a depth of 1 to 3 μm.
